(19) United States
(12) Patent Application Publication
(10) Pub. No.: US 2026/0175665 A1
(43) Pub. Date: Jun. 25, 2026

(54) SYSTEM FOR A DISCHARGE DEVICE

(71) Applicant: Ford Global Technologies, LLC, Dearborn, MI (US)

(72) Inventors: Emad Al-Regib, Canton, MI (US); Kristen Mannion, Carrboro, NC (US)

(21) Appl. No.: 18/987,092

(22) Filed: Dec. 19, 2024

(51) Int. Cl. B60K 1/00

(52) U.S. Cl. CPC B60K 1/00

(57) ABSTRACT

Methods and systems are provided for a discharge device. In one example, a system includes a discharge device comprising a mounting chassis coupled to a ground, a plurality of arms coupled to the mounting chassis, and a resilient element arranged between the mounting chassis and the plurality of arms. The discharge device is arranged within a power drive unit.

### FIELD

The present description relates generally to a discharge device.

### BACKGROUND/SUMMARY

Vehicles with electric motors or hybrid transmission may produce excess electrical energy. The excess electrical energy may collect in an input shaft of a motor.

In one example, a system is provided including a discharge device including a mounting chassis coupled to a ground, a plurality of arms coupled to the mounting chassis, and a resilient element arranged between the mounting chassis and the plurality of arms. In this way, service and installation of a grounding device may be simplified.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The advantages described herein will be more fully understood by reading an example of an embodiment, referred to herein as the Detailed Description, when taken alone or with reference to the drawings, where:

FIG. 1 shows an example of a vehicle system; and

FIG. 2 shows a perspective view of a discharge device of a power drive unit.

### DETAILED DESCRIPTION

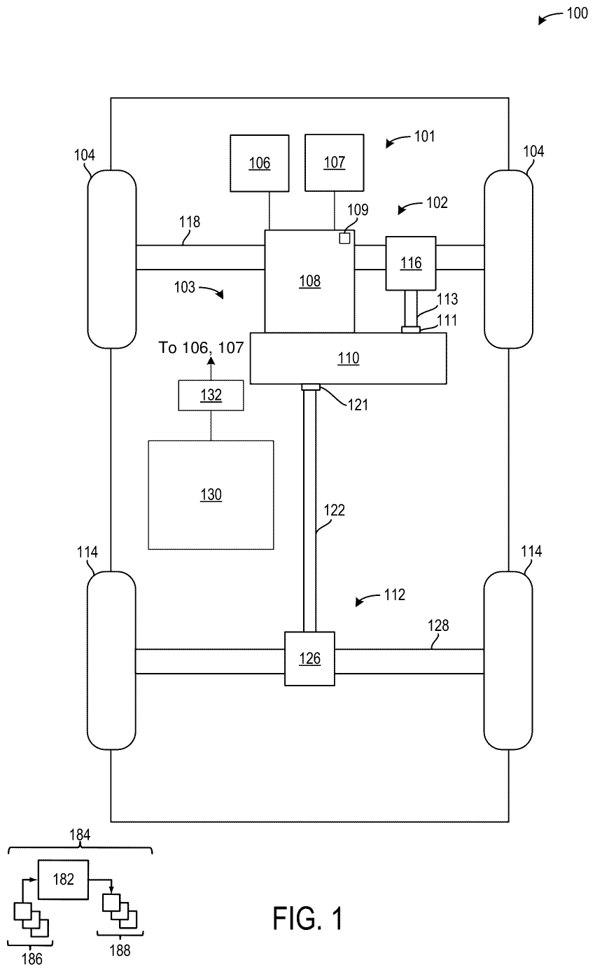

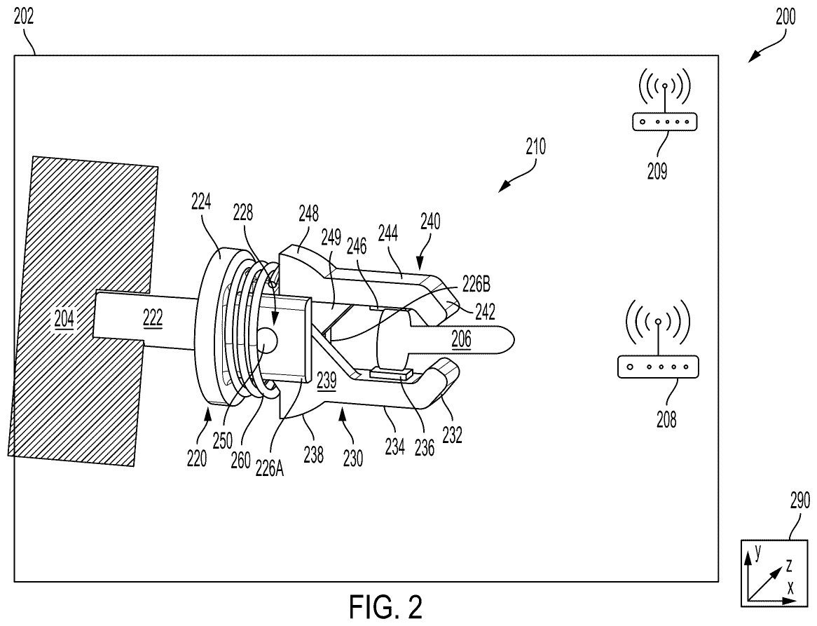

The following description relates to systems for a discharge device. The discharge device may be arranged in a power drive unit of a vehicle system, such as the vehicle system shown in FIG. 1. FIG. 2 shows a perspective view of the discharge device.

Vehicles with electric motors or hybrid transmission may produce excess electrical energy. The excess electrical energy may collect in an input shaft of a motor. If the input shaft is not sufficiently grounded, then the electricity may arc and transfer to other metal components inside a power drive unit and/or the transmission. The electrical arcing may reduce a longevity of the components. Solutions alternative to those that already exist may be desired. Various approaches are provided herein for providing a discharge device to discharge stored energy.

The discharge device may include one or more of, or each of, four distinct components including a mounting chassis, a plurality of arms, a plurality of brushes, a pin, and a resilient element. The mounting chassis may be coupled to a casting cover of a power drive unit and configured to support the arms, brushes, pin, and resilient member. The plurality of arms may be coupled to the mounting chassis via the pin. Each arm of the plurality of arms may include a brush. The plurality of arms may clamp a shaft of the electric motor via forces provided by the resilient element. In one example, the shaft is a rotating shaft configured to carry electric charge from the electric motor. Electric charges carried by the shaft may be discharged through contact with the plurality of brushes as the shaft rotates between the plurality of arms. The electrical charges may dissipate through the arms, the pin, the resilient member, to the chassis, and grounded to a casting cover.

Turning now to FIG. 1, a vehicle 100 is shown comprising a powertrain 101 and a drivetrain 103. The powertrain comprises a prime mover 106 and a transmission 108. The prime mover 106 may be an internal combustion engine or an electric motor, for example, and is operated to provide rotary power to the transmission 108. The transmission 108 may be any type of transmission, such as a manual transmission, an automatic transmission, or a continuously variable transmission. The transmission 108 receives the rotary power produced by the prime mover 106 as an input and outputs rotary power to the drivetrain 103 in accordance with a selected gear or setting. The transmission 108 may include a vent device 109 coupled to a fitting of a housing of the transmission 108.

In one example, the prime mover 106 is a first prime mover 106 and the vehicle 100 may further include a second prime mover 107. The first prime mover 106 may be different than the second prime mover 107. For example, the first prime mover 106 may be an electric machine and the second prime mover 107 may be an internal combustion engine. Additionally or alternatively, the first prime mover 106 and the second prime mover 107 may both be an electric motor. Additionally or alternatively, if one of the first prime mover 106 and the second prime mover 107 is an engine, the engine may be configured to combust multiple fuels including varying amounts of carbon and carbon-free fuels.

Each of the first prime mover 106 and the second prime mover 107 may be coupled to an energy storage device. The energy storage device may be a battery, a fuel tank, or other similar device. A charge of fuel volume of the energy storage device may be monitored via a sensor or estimated based on vehicle operating conditions. In one example, one or more of the first prime mover 106 and the second prime mover 107 may be configured to replenish a charge of the energy storage device during a generator operation.

In one example, a battery 130 may be coupled to a power drive unit 132. The power drive unit 132 may be configured to distribute electrical power from the battery 130 to a plurality of vehicle components, including at least the first prime mover 106 and the second prime mover 107. In one example, a motor control unit may be coupled to the power drive unit 132, wherein the motor control unit may meter power to the first prime mover 106 and the second prime mover 107 based on conditions. The power drive unit 132 and a discharge device thereof are described in greater detail below. A mounting location of the battery 130 and the power drive unit 132 illustrated in the example of FIG. 1 may be modified without departing from the scope of the present disclosure.

The vehicle 100 may be a commercial vehicle, light, medium, or heavy duty vehicle, a passenger vehicle, an off-highway vehicle, a locomotive, and a sport utility vehicle. Additionally or alternatively, the vehicle 100 and/or one or more of its components may be in industrial, locomotive, military, agricultural, and aerospace applications.

In some examples, such as shown in FIG. 1, the drivetrain 103 includes a first axle assembly 102 and a second axle assembly 112. The first axle assembly 102 may be configured to drive a first set of wheels 104, and the second axle assembly 112 may be configured to drive a second set of wheels 114. In one example, the first axle assembly 102 is arranged near a front of the vehicle 100 and thereby comprises a front axle, and the second axle assembly 112 is arranged near a rear of the vehicle 100 and thereby comprises a rear axle. The drivetrain 103 is shown in a four-wheel drive configuration, although other configurations are possible. For example, the drivetrain 103 may include a front-wheel drive, a rear-wheel drive, or an all-wheel drive configuration. Further, the drivetrain 103 may include one or more tandem axle assemblies. As such, the drivetrain 103 may have other configurations without departing from the scope of this disclosure, and the configuration shown in FIG. 1 is provided for illustration, not limitation. Further, the vehicle 100 may include additional wheels that are not coupled to the drivetrain 103.

In some four-wheel drive configurations, such as shown in FIG. 1, the drivetrain 103 includes a transfer case 110 configured to receive rotary power output by the transmission 108. A first driveshaft 113 is drivingly coupled to a first output 111 of the transfer case 110, while a second driveshaft 122 is drivingly coupled to a second output 121 of the transfer case 110. The first driveshaft 113 (e.g., a front driveshaft) transmits rotary power from the transfer case 110 to a first differential 116 of the first axle assembly 102 to drive the first set of wheels 104, while the second driveshaft 122 (e.g., a rear driveshaft) transmits the rotary power from the transfer case 110 to a second differential 126 of the second axle assembly 112 to drive the second set of wheels 114. For example, the first differential 116 is drivingly coupled to a first set of axle shafts 118 coupled to the first set of wheels 104, and the second differential 126 is drivingly coupled to a second set of axle shafts 128 coupled to the second set of wheels 114. It may be appreciated that each of the first set of axle shafts 118 and the second set of axle shafts 128 may be positioned in a housing.

In some examples, additionally or alternatively, the vehicle 100 may be a hybrid vehicle including both the engine and the electric machine each configured to supply power to one or more of the first axle assembly 102 and the second axle assembly 112. For example, one or both of the first axle assembly 102 and the second axle assembly 112 may be driven via power originating from the engine in a first operating mode where the electric machine is not operated to provide power (e.g., an engine-only mode), via power originating from the electric machine in a second operating mode where the engine is not operated to provide power (e.g., an electric-only mode), and via power originating from both the engine and the electric machine in a third operating mode (e.g., an electric assist mode). As another example, one or both of the first axle assembly 102 and the second axle assembly 112 may be an electric axle assembly configured to be driven by an integrated electric machine.

The vehicle 100 may further include a control system 184. Control system 184 is shown comprising a controller 182 receiving information from a plurality of sensors 186 and sending control signals to a plurality of actuators 188. The controller 182 may receive input data from the various sensors, process the input data, and trigger the actuators in response to the processed input data based on instruction or code programmed therein corresponding to one or more routines. The plurality of sensors 186 may include speed sensors, temperature sensors, humidity sensors, location sensors, accelerometers, and the like. The plurality of actuators 188 may be actuators of one more valves, motors, and other devices.

Turning now to FIG. 2, it shows an embodiment 200 of a power drive unit 202. In one example, the power drive unit 202 is identical to the power drive unit 132 of FIG. 1. As such, the power drive unit 202 may include a drive unit port 208 configured to output electrical energy to a drive unit. The power drive unit 202 may further include an inverter system controller (ISC) 209. The ISC may include a controller and an inverter configured to convert DC to AC or vice-versa, between the motor and the battery. The ISC 209 may emit electromagnetic radiation.

Each of the motor 208 and the ISC 209 may emit electromagnetic radiation. The discharge device described herein may be configured to ground each source of electromagnetic radiation with the power drive unit 202. In some examples, additionally or alternatively, more than one discharge device may be positioned within the power drive unit 202 without departing from the scope of the present disclosure.

An axis system 290 is shown comprising three axes, namely an x-axis parallel to a horizontal direction, a y-axis parallel to a vertical direction, and a z-axis normal to the x-and y-axes. A direction of gravity may be opposite and parallel to the y-axis.

The power drive unit 202 may further include a discharge device 210. In one example, the discharge device 210 may be an assembly including a plurality of components coupled to one another and configured to dissipate excess electrical energy. The discharge device 210 may include a mounting chassis 220, a plurality of arms including a first arm 230 and a second arm 240, a pin 250, and a resilient member 260.

The mounting chassis 220 may include a shaft 222, a disk 224, and a fork including a first prong 226A and a second prong 226B. The mounting chassis 220 may be configured as a single piece such that welds, adhesives, fusions, fasteners, and/or any other couplings are not present between the shaft 222, the disk 224, and the fork.

The shaft 222 may include a cylindrical shape. The shaft 222 may extend from the disk 224 to a metal case 204 of the power drive unit 202. In one example, the metal case 204 may function as a ground such that electric energy directed thereto is dissipated. The dissipated electrical energy may no longer be able to arc. The metal case 204 may be interchangeably referred to as the ground 204 herein.

The shaft 222 of the mounting chassis 220 may be threaded or press fit into the metal case 204 of the power drive unit 202. In this way, the discharge device 210 may be cantilevered to the metal case 204 via the shaft 222.

The disk 224 may include a cylindrical shape. In one example, the disk 224 may include a diameter larger than a diameter of the shaft 222. Additionally or alternatively, a height of the disk 224 may be less than a height of the shaft 222.

The fork may extend from a second side of the disk 224, wherein the shaft 222 extends from a first side of the disk 224, opposite the second side. The fork may include the first prong 226A and the second prong 226B, wherein the first prong 226A and the second prong 226B are identical in size and shape. A majority of the second prong 226B is occluded from view in the example of FIG. 2. However, description related to the first prong 226A may be applied to the second prong 226B.

The first prong 226A may include a rectangular prism shape. The first prong 226A may extend from an area of the second side near a perimeter of the disk 224. The first prong 226A may include an opening 228. The opening 228 may extend through an entirety of the first prong 226A. The opening 228 may align with a corresponding opening of the second prong 226B such that the pin 250 may be inserted therethrough.

The plurality of arms may be inserted into a gap between the first prong 226A and the second prong 226B. The plurality of arms may be in face-sharing contact with one another and surfaces of the first prong 226A and the second prong 226B. For example, a first arm 230 may be in face-sharing contact with a surface of the first prong 226A. A second arm 240 may be in face-sharing contact with a surface of the second prong 226B. The first arm 230 may be identical to the second arm 240 in size and shape. An orientation of the first arm 230 may be opposite an orientation of the second arm 240. In one example, the second arm 240 is flipped 180° about the x-axis relative to the first arm 230.

The first arm 230 may include a tip 232 extending from a base 234. The base 234 may be parallel to the shaft 222. The tip 232 may be angled relative to the base 234. In one example, the tip 232 is angled such that it extends toward the second arm 240. A first brush 236 may be coupled to the base 234. The first brush 236 may be coupled to a surface of the base 234 facing the second arm 240. The first brush 236 may be a carbon brush or a silver impregnated carbon brush pad.

The base 234 may be coupled to a body 239. The body 239 may correspond to a portion of the first arm 230 arranged between the first prong 226A and second prong 226B. The body 239 may include a through-hole that aligns with the opening 228 of the first prong 226A.

A first fin 238 may extend from an interface between the base 234 and the body 239. The first fin 238 may include a triangular shape. In one example, the first fin 238 may press against the resilient member 260, as will be described in greater detail below. The first fin 238 may extend in a direction away from the second arm 240.

The first arm 230 may be configured as a single piece. As such, there may be no welds, adhesives, fusions, fastener, or other couplings between the tip 232, the body 239, the first brush 236, the first fin 238, and the body 239.

The second arm 240 may include a tip 242 extending from a base 244. The base 244 may be parallel to the shaft 22 and to the base 234. The tip 242 may be angled relative to the base 244. In one example, the tip 242 may extend toward the tip 232 of the first arm 230 such that a gap between the tip 242 and the tip 232 is less than a gap between the base 234 and the base 244.

The base 244 may be coupled to a body 249. The body 249 may correspond to a portion of the second arm 240 arranged between the first prong 226A and the second prong 226B. The body 249 may include a through-hole that aligns with the opening 228 and the through-hole of the body 239. The body 249 may be in face-sharing contact with each of the second prong 226B and the body 239. The body 239 may be in face-sharing contact with each of the first prong 226A and the body 249.

A second fin 248 may extend from an interface between the base 244 and the body 249. The second fin 248 may include a triangular shape. In one example, the second fin 248 may press against the resilient member 260, as will be described in greater detail below. The second fin 248 may extend in a direction away from the first arm 230.

The first fin 238 and the second fin 248 may be in face-sharing contact with the resilient member 260. The resilient member 260 may press against each of the disk 224, the first fin 238, and the second fin 248. A force applied from the resilient member 260 may force the first arm 230 and the second arm 240 to clamp about a rotating shaft 206. In one example, the rotating shaft 206 is a shaft of an electric motor (e.g., first prime mover 106 or second prime mover 107 of FIG. 1). In one example, the shaft of the electric motor may extend from the electric motor to a wheel end, a gear box, or other device. The first arm 230 and the second arm 240 may clamp along a location of the shaft between extreme ends of the shaft. The clamping force may reduce a gap between the first arm 230 and the second arm 240 such that the rotating shaft 206 is in contact with the first brush 236 and the second brush 246 and configured to rotate without contacting other areas of the first arm 230 and the second arm 240.

Additionally or alternatively, the shaft 206 may protrude from the motor 208. The discharge device 210 may be coupled to a first extreme end of the shaft 206, wherein a second extreme end of the shaft 206 is adjacent to the ISC 209. The first extreme end is opposite the second extreme end. As described above, the discharge device 210 may be one of a plurality of discharge devices. The discharge devices may be positioned such that a distance between a discharge device and a source of electromagnetic radiation is minimized.

In one example, the resilient member 260 is a spring. The spring may extend around a circumference of the fork including the first prong 226A and the second prong 226B. The spring may be retained around the fork via surfaces of the disk 224, the first fin 238 of the first arm 230, and the second fin 248 of the second arm 240.

In this way, electric charges from the rotating shaft 206 may pass through contact with the first brush 236 and the second brush 246 as the rotating shaft 206 rotates within the gap between the first arm 230 and the second arm 240. The electric charges may dissipate through the first arm 230 and the second arm 240, and then to the pin 250. From the pin 250, the electric charges may pass to the resilient member 260, and then to the mounting chassis 220. From the mounting chassis 220, the electric charges may flow to the metal case 204 where the charges may dissipate, thereby mitigate a likelihood of arcing. By doing this, a longevity of components may be increased.

The discharge device 210 of FIG. 2 may discharge a relatively high amount of electromagnetic radiation via the two brushes. The plurality of arms may provide more lateral translation of the shaft and components, which may simplify assembly and operation. The discharge device 210 may be sized to package into the power drive unit packaging space and to meet an electromagnetic radiation level and frequency of the power drive unit. The relatively low number of components of the discharge device 210 may increase an assembly efficiency and simplify servicing of components.

The disclosure also provides support for a system including a discharge device comprising a mounting chassis coupled to a ground, a plurality of arms coupled to the mounting chassis, and a resilient element arranged between the mounting chassis and the plurality of arms. In a first example of the system, each of the plurality of arms comprises a brush. In a second example of the system, optionally including the first example, the brush is a carbon brush or a silver impregnated carbon brush. In a third example of the system, optionally including one or both of the first and second examples, the resilient element is a spring applying a force to the plurality of arms. In a fourth example of the system, optionally including one or more or each of the first through third examples, the system further comprises: a pin coupling the plurality of arms to the mounting chassis. In a fifth example of the system, optionally including one or more or each of the first through fourth examples, the ground is a metal case of a power drive unit. In a sixth example of the system, optionally including one or more or each of the first through fifth examples, the mounting chassis comprises a shaft inserted into the ground.

The disclosure also provides support for a system including a power drive unit comprising a metal case, and a discharge device coupled to the metal case via a mounting chassis, wherein the discharge device comprises a plurality of arms each comprising a brush in contact with a rotating shaft. In a first example of the system, the plurality of arms is coupled to a fork of the mounting chassis via a pin. In a second example of the system, optionally including the first example, the plurality of arms clamps the rotating shaft via a force provided by a resilient member. In a third example of the system, optionally including one or both of the first and second examples, the resilient member presses against the plurality of arms and the mounting chassis. In a fourth example of the system, optionally including one or more or each of the first through third examples, the rotating shaft is configured to rotate while clamped by the plurality of arms. In a fifth example of the system, optionally including one or more or each of the first through fourth examples, each of the plurality of arms is identical to one another. In a sixth example of the system, optionally including one or more or each of the first through fifth examples, the mounting chassis is a single piece. In a seventh example of the system, optionally including one or more or each of the first through sixth examples, the discharge device is arranged within the power drive unit.

The disclosure also provides support for a system of a discharge device, comprising: a mounting chassis coupled to a ground, a plurality of clamping arms coupled to the mounting chassis via a pin, wherein each of the plurality of clamping arms comprises a brush pad, and a spring positioned between the mounting chassis and the plurality of clamping arms, wherein the spring forces the plurality of clamping arms to clamp a carrier of an electric charge. In a first example of the system, the brush pad of each of the plurality of arms contacts the carrier. In a second example of the system, optionally including the first example, the pin is inserted through a through-hole of a fork of the mounting chassis and through openings of the plurality of clamping arms. In a third example of the system, optionally including one or both of the first and second examples, the ground is a metal case of a power drive unit, and wherein the mounting device is arranged within the power drive unit. In a fourth example of the system, optionally including one or more or each of the first through third examples, the carrier is a rotating shaft of a motor.

FIGS. 1-2 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. It will be appreciated that one or more components referred to as being “substantially similar and/or identical” differ from one another according to manufacturing tolerances (e.g., within up to 5% deviation). FIG. 2 is shown approximately to scale. Other relative dimensions may be used if desired.

It will be appreciated that the configurations and routines disclosed herein are exemplary in nature, and that these specific embodiments are not to be considered in a limiting sense, because numerous variations are possible. For example, the above technology can be applied to V-6, I-4, I-6, V-12, opposed 4, and other engine types. The subject matter of the present disclosure includes all novel and non-obvious combinations and sub-combinations of the various systems and configurations, and other features, functions, and/or properties disclosed herein.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A system, comprising:
a discharge device comprising a mounting chassis coupled to a ground;
a plurality of arms coupled to the mounting chassis; and
a resilient element arranged between the mounting chassis and the plurality of arms.

2. The system of claim 1, wherein each of the plurality of arms comprises a brush.

3. The system of claim 2, wherein the brush is a carbon brush or a silver impregnated carbon brush.

4. The system of claim 1, wherein the resilient element is a spring applying a force to the plurality of arms.

5. The system of claim 1, further comprising a pin coupling the plurality of arms to the mounting chassis.

6. The system of claim 1, wherein the ground is a metal case of a power drive unit.

7. The system of claim 1, wherein the mounting chassis comprises a shaft inserted into the ground.

8. A system, comprising:
a power drive unit comprising a metal case; and
a discharge device coupled to the metal case via a mounting chassis, wherein the discharge device comprises a plurality of arms each comprising a brush in contact with a rotating shaft.

9. The system of claim 8, wherein the plurality of arms is coupled to a fork of the mounting chassis via a pin.

10. The system of claim 8, wherein the plurality of arms clamps the rotating shaft via a force provided by a resilient member.

11. The system of claim 10, wherein the resilient member presses against the plurality of arms and the mounting chassis.

12. The system of claim 10, wherein the rotating shaft is configured to rotate while clamped by the plurality of arms.

13. The system of claim 10, wherein each of the plurality of arms is identical to one another.

14. The system of claim 8, wherein the mounting chassis is a single piece.

15. The system of claim 8, wherein the discharge device is arranged within the power drive unit.

16. A system of a discharge device, comprising:
a mounting chassis coupled to a ground;
a plurality of clamping arms coupled to the mounting chassis via a pin, wherein each of the plurality of clamping arms comprises a brush pad; and
a spring positioned between the mounting chassis and the plurality of clamping arms, wherein the spring forces the plurality of clamping arms to clamp a carrier of an electric charge.

17. The system of claim 16, wherein the brush pad of each of the plurality of clamping arms contacts the carrier.

18. The system of claim 16, wherein the pin is inserted through a through-hole of a fork of the mounting chassis and through openings of the plurality of clamping arms.

19. The system of claim 16, wherein the ground is a metal case of a power drive unit, and wherein the discharge device is arranged within the power drive unit.

20. The system of claim 16, wherein the carrier is a rotating shaft of a motor.
